(19) United States
(12) Patent Application Publication
(10) Pub. No.: US 2008/0235778 A1
(43) Pub. Date: Sep. 25, 2008

(54) COMMUNICATION NETWORK, AN ACCESS NETWORK ELEMENT AND A METHOD OF OPERATION THEREFOR

(75) Inventors: Marco Fratti, Saint Germain en Laye (FR); Dragan M. Boscovic, South Barrington, IL (US); Rajesh Tyagi, Ayer, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/688,965

(22) Filed: Mar. 21, 2007

(51) Int. Cl. G06F 17/30

(52) U.S. Cl. 726/8

(57) ABSTRACT

An access network element provides user equipment access to a network comprising a centralised authentication server. The access network element comprises an authentication processor which authenticates the access network element at the centralised authentication server. In addition, the access network element authenticates a first user equipment in response to the authentication of the access network element by the centralised authentication server. A communication processor supports a peer-to-peer first communication session for the first user equipment and a peer-to-peer second communication session with a second access network element which supports a peer-to-peer communication session with a second user equipment. Peer-to-peer communication between the first and second user equipments is supported by exchanging data between the first communication session and the second communication session. The invention may allow benefits of de-centralised peer-to-peer communications to be combined with existing centralised network architectures such as the Internet Protocol Multimedia Subsystem, IMS.

### FIELD OF THE INVENTION

The invention relates to a communication network, an access network element and a method of operation therefor and in particular, but not exclusively to an Internet Protocol Multimedia Subsystem (IMS) based communication network.

### BACKGROUND OF THE INVENTION

In the future evolution of cellular communication systems, it is expected that these will increasingly be based on Internet Protocol (IP) traffic. For example, it is envisaged that a substantial part of the voice communication will be supported by Voice over IP (VoIP) traffic in the future.

Accordingly, the 3^{rd} Generation Partnership Project (3GPP), which is responsible for standardising the 3^{rd} Generation cellular communication systems, has introduced a network architecture which supports IP traffic. This architecture is compatible with and supplements the traditional network architecture and is known as the IP Multimedia Subsystem (IMS).

The aim of IMS is not only to provide new services but to provide all the services, current and future, that the Internet provides. In addition, users have to be able to execute all their services when roaming as well as from their home networks. To achieve these goals, IMS uses open standard IP protocols, defined by the Internet Engineering Task Force (IETF). So, a multimedia session between two IMS users, between an IMS user and a user on the Internet, and between two users on the Internet is established using exactly the same protocol.

In particular, IMS uses a VoIP implementation based on a 3GPP standardised implementation of SIP and runs over the standard Internet Protocol (IP). Existing phone systems (both packet-switched and circuit-switched) are supported.

SIP is a standard for initiating, modifying, and terminating an interactive user session that involves multimedia elements such as video, voice, instant messaging, online games, and virtual reality. SIP is only used in setting up and tearing down voice or video calls. All voice/video communications are done over the Real-time Transport Protocol (RTP).

A goal for SIP is to provide a superset of the call processing functions and features present in the public switched telephone network (PSTN). As such, features that permit familiar telephone-like operations are present including dialing a telephone number, causing a phone to ring, hearing ringback tones etc.

SIP also implements many more advanced call processing features. Furthermore, SIP is a peer-to-peer protocol. As such, it requires only a very simple (and thus highly scalable) core network with intelligence distributed to the network edge, embedded in endpoints (terminating devices built in either hardware or software). Many SIP features are implemented in the communicating endpoints.

IMS supports functionality for managing and controlling subscription information for the users of the system. Specifically, an IMS network comprises a Home Subscriber Server (HSS) which is a master user database that supports the IMS network entities that are actually handling the calls/sessions. These entities comprise the so-called Call Server Control Function (CSCF) elements. A CSCF also acts as a SIP Registrar and stores registration information (such as public identity, private identity, contacts [the IP address of a device, capabilities]). It contains the subscription-related information (user profiles), performs authentication and authorization of the user, and can provide information about the physical location of user. A HSS may in many scenarios be considered to provide functionality equivalent to a GSM Home Location Register (HLR) and Authentication Center (AuC).

Similarly to other proposed IP multimedia solutions, the IMS network architecture and approach is highly centralized. For example, a centralized application server is used to provide suitable interfaces (Application Programming Interfaces —APIs) for 3^{rd} party application developers, a centralized network service platform is used for providing the necessary network services for running the applications (e.g. presence, authentication, mobility, etc.) and centralized session controllers are used for session origination/modification/termination, quality of service control, charging data records, etc.

However, although a communication system based on an IMS framework may provide efficient performance in many scenarios, it is also associated with a number of disadvantages.

For example, introduction of IMS to a legacy network can be relatively complex and expensive. Specifically, the IMS functions strongly impact existing core network elements and the user equipments. Accordingly, an IMS system requires that a massive simultaneous upgrade of several service-based and connectivity-based modules must be performed.

Also, as IMS was originally introduced as an application support framework for UMTS, the adaptation to different access networks tends to be relatively difficult, especially for wired access networks.

Furthermore, as IMS is intrinsically a centralized solution a number of disadvantages typical of centralized networks are also present in IMS. For example, coverage, scalability and management flexibility, efficiency and complexity tend to be suboptimal.

IMS is also associated with a high cost of entry and in particular the centralized network-based architecture requires that any incumbent operator makes a significant infrastructure investment decision prior to enabling any revenue generating applications.

Hence, an improved system would be advantageous and in particular a system allowing increased flexibility, facilitated implementation, facilitated operation and/or management; reduced complexity, reduced cost-of-entry and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an access network element for providing access to a network for user equipments, the network comprising a centralised authentication server and the access network element comprising: first authentication means for authenticating the access network element at the centralised authentication server; second authentication means for authenticating the first user equipment in response to the authentication of the access network element by the centralised authentication server; first communication session means for supporting a peer-to-peer first communication session for the first user equipment; second communication session means for supporting a peer-to-peer second communication session with a second access network element supporting a peer-to-peer communication session with a second user equipment; and means for supporting a peer-to-peer communication between the first and second user equipments by exchanging data between the first communication session and the second communication session. The invention may provide for an improved communication system and may in particular allow improved operation, management, implementation and/or performance.

The invention may provide an efficient, reliable and secure network without requiring full centralisation. Furthermore, the invention may provide an improved flexibility and facilitated adaptability by locating authentication functionality for peer-to-peer communications at the access network edge. A reduced impact on existing and centralised functions may be achieved and the barrier to entry may be substantially reduced as the cost and infrastructure required may be reduced substantially.

The invention may allow an effective network architecture where peer-to-peer communication sessions based on distributed functionality can efficiently co-exist with client-server based communication sessions based on a centralised approach.

The approach may specifically be compatible with existing centralised architecture approaches, such as an IMS network architecture. Specifically, the authentication of an access network element and/or a user equipment may be performed in response to an authentication data exchange with a central authentication server which specifically may be an IMS authentication server.

The access network element may be an access network element of an IMS network. The user equipment may for example be an end user terminal, a third generation User Equipment, a mobile station or any other entity capable of accessing the network via the access network element.

According to another aspect of the invention, there is provided a communication network comprising at least one a centralised authentication server and a plurality of access network elements for providing access to the network for user equipments, at least one access network element of the plurality of access network elements comprising: first authentication means for authenticating the access network element at the centralised authentication server; second authentication means for authenticating the first user equipment in response to the authentication of the access network element by the centralised authentication server; first communication session means for supporting a peer-to-peer first communication session for the first user equipment; second communication session means for supporting a peer-to-peer second communication session with a second access network element supporting a peer-to-peer communication session with a second user equipment; and means for supporting a peer-to-peer communication between the first and second user equipments by exchanging data between the first communication session and the second communication session.

According to another aspect of the invention, there is provided a method of operation for an access network element providing access to a network for user equipments, the access network comprising a centralised authentication server and the method comprising: authenticating the access network element at the centralised authentication server; authenticating the first user equipment in response to the authentication of the access network element by the centralised authentication server; supporting a peer-to-peer first communication session for the first user equipment; supporting a peer-to-peer second communication session with a second access network element supporting a peer-to-peer communication session with a second user equipment; and supporting a peer-to-peer communication between the first and second user equipments by exchanging data between the first communication session and the second communication session.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a communication system in accordance with some embodiments of the invention;

FIG. 2 illustrates an example of an access network element in accordance with some embodiments of the invention;

FIG. 3 illustrates an example of a specific message flow in a communication system in accordance with some embodiments of the invention; and

FIG. 4 illustrates an example of a method of operation for an access network element in accordance with some embodiments of the invention.

### DETAILED DESCRIPTION OF SOME EMBODIMENTS OF THE INVENTION

The following description focuses on embodiments of the invention applicable to a communication system employing an Internet Protocol Multimedia Subsystem (IMS) network and in particular to an IMS network using SIP for communication session setup and management. However, it will be appreciated that the invention is not limited to this application but may be applied to many other communication systems and networks.

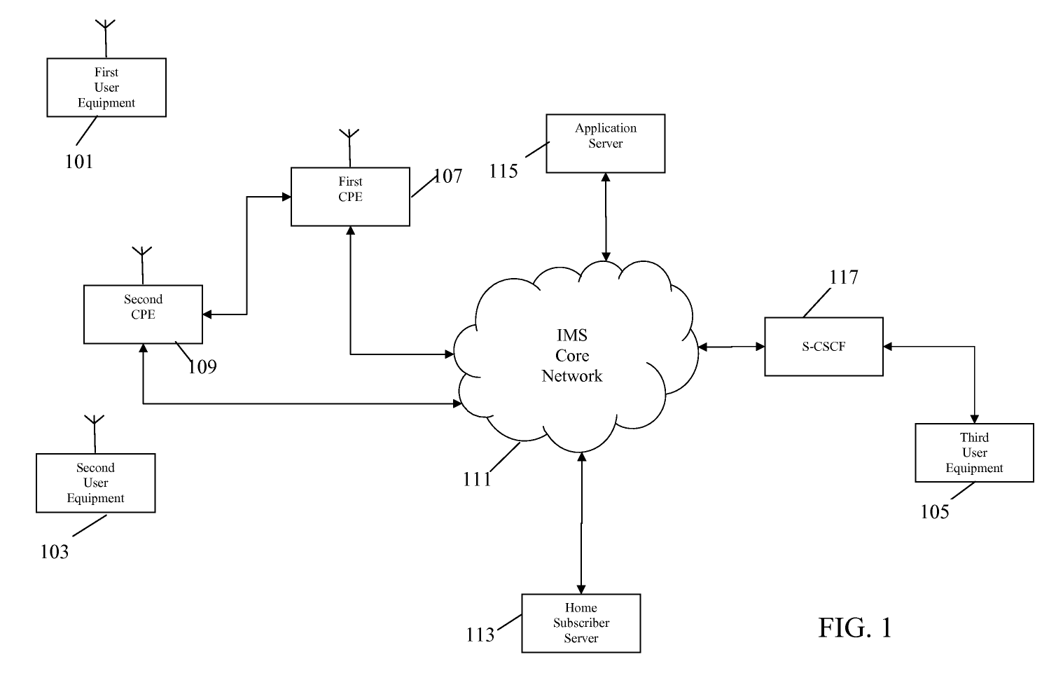

FIG. 1 illustrates a communication system in accordance with some embodiments of the invention. The communication system employs an IMS network which comprises the functionality for providing traditional IMS communication services. Furthermore, the system comprises functionality allowing peer-to-peer communications to be established between different user equipments of the system. Thus, in addition to providing conventional IMS service and functionality, the system also allows server-less peer-to-peer operations between user equipments. Such peer-to-peer operations are achieved through peer-to-peer communications established between the individual user equipment and its access point as well as between the two access points supporting the user equipments.

Thus, contrary to a conventional centralised IMS architecture, the system of FIG. 1 further uses a distributed approach with much of the IMS functionality being located in the network elements at the network edge.

The system of FIG. 1 comprises a plurality of user equipments (only three of which are shown) 101, 103, 105 which may communicate with each other or access other available services and applications. The system furthermore comprises a number of access network elements which are used by user equipments 101, 103 to access the IMS network. In the specific example, two access network elements 107, 109 are illustrated supporting respectively the first user equipment 101 and the second user equipment 103 via air interface communications of the cellular communication system. In the specific example, the two access network elements 107, 109 are Customer Premise Equipment (also sometimes referred to as Customer Provided Equipment) which in the specific example may be located in e.g. an office or an individual subscriber's home. A Customer Premise Equipment (CPE) is generally considered to be any terminal and associated equipment and inside wiring located at a subscriber's premises and connected with a carrier's telecommunication channel(s) at a demarcation point.

The CPEs 107, 109 are coupled to an IMS core network 111 which comprises IMS functionality for routing, addressing, charging etc. in accordance with the specifications of IMS, the CPEs 107, 109 may for example be coupled to the same IMS border router either by a direct connection or by a logical connection.

In addition, the first and second CPEs 107, 109 are coupled directly together through a suitable logical or actual connection. Specifically, the direct coupling between the first and second CPEs 107, 109 may be as a logical connection through the IMS core network 111.

The IMS core network 111 is coupled to a Home Subscriber Server (HSS) 113 and an Application Server (AS) 115. The HSS 113 comprises the master user database for the IMS network and supports the IMS network entities that are actually handling the calls/sessions. It contains subscription-related information (user profiles), performs authentication and authorization of the user, and can provide information about the physical location of user. Specifically, the HSS 113 can be considered to include authentication server functionality allowing individual network entities and user equipments to be authenticated.

The AS 115 provides application hosting and common interfacing for a range of service applications provided by the network.

The IMS core network 111 is furthermore coupled to a serving-Call Session Control Function (S-CSCF) 117 which serves the third user equipment 105. The S-CSCF 117 comprises the necessary IMS functionality for supporting the third user equipment 105 including functionality for session setup and management, registration, mobility control etc. In the specific example, the S-CSCF 117 is coupled to an Interrogating-CSCF (I-CSCF) (not shown) which acts as an IMS border router.

In the system, the third user equipment 105 interacts with the IMS core network 111 in a conventional fashion using IMS techniques. The first and second user equipments 101, 103 however connect to the first and second CPEs 107, 109 using peer-to-peer techniques. For a communication between the first and third user equipments 101, 105, the first CPE 107 interfaces with the IMS core network 111 to provide a communication session which is indistinguishable from a conventional IMS communication session. However, if the first user equipment 101 communicates with the second user equipment 103, the first and second CPEs 107, 109 comprise functionality for establishing a peer-to-peer communication between them in order to support the communication. Accordingly, the system achieves an effective peer-to-peer communication between the first and the second user equipment 101, 103 through peer-to-peer communications between each of the user equipments 101, 103 and their respective CPEs 107, 109 as well as a peer-to-peer communication between the respective CPEs 107, 109.

In order to support such peer-to-peer communications while providing IMS compatibility and the required reliability, security, user adaptation etc, the system of FIG. 1 provides additional functionality at the network edge (i.e. in the CPEs) rather than it (just) being implemented centrally as for a conventional IMS system.

Specifically, the CPEs are modified to including CSCF functionality including possibly elements of both S-CSCF, I-CSCF and Proxy-CSCFs.

Specifically, the CPE CSCF can include functionality for the following operations:
Managing session set-up and tear-down for sessions being either originated or terminated in a user equipment supported by the CPE.
Managing the end-user identities for the user equipments registered with the CPE thereby providing identification features for a peer CPE.
Routing of peer-to-peer data based on the called end-user identity. The CPE is able to identify the peer CPE to which the called user equipment is connected.
Collecting charging-related information
Creating a security association between itself and its connected UE.
Call Admission Control (CAC) support.

A critical requirement for a system using distributed functionality is that authentication remains reliable and secure.

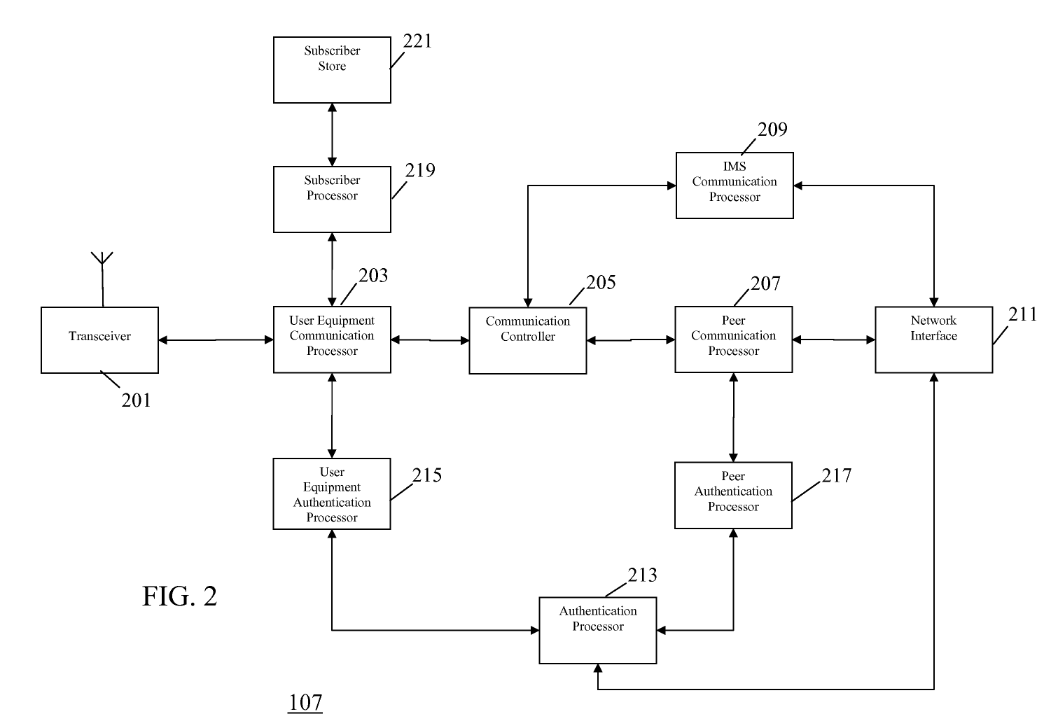

FIG. 2 illustrates an access network element in accordance with some embodiments of the invention. In particular, FIG. 2 may illustrate elements of the first CPE 107 of the system of FIG. 1 and will be described with reference thereto. The second CPE 109 may be identical to the first CPE 107.

The first CPE 107 comprises a transceiver 201 which is capable of communicating with the first user equipment 101 over the air interface of the cellular communication system. It will be appreciated that in other embodiments, other communication systems may be used for communication between the first user equipment 101 and the first CPE 107. Specifically, a local communication system (such as a WLAN network) can be used. Also, wired communication means (such as a LAN network) can provide connectivity between the first CPE 107 and the first user equipment 101. Indeed, any form of e.g. IP connectivity may be used for the communication.

The transceiver 201 is coupled to a user equipment communication processor 203 which comprises functionality for managing a peer-to-peer first communication session for the first user equipment 101. Specifically, the user equipment communication processor 203 can comprise a SIP server which interfaces with a SIP client of the first user equipment 101 to set up new communication sessions, terminating existing sessions etc. The user equipment communication processor 203 is furthermore capable of exchanging data of the communication session with the first user equipment 101 using a suitable protocol and in accordance with the technical specifications of the cellular communication system.

The user equipment communication processor 203 is coupled to a communication controller 205 which is arranged modify the operation of the first CPE 107 depending on whether a peer-to-peer or conventional IMS remote user equipment is supported.

Specifically, the communication controller 205 is coupled to a peer communication processor 207 and an IMS communication processor 209. The communication controller 205 effectively couples the user equipment communication processor 203 and the peer communication processor 207 together when a peer-to-peer communication is supported and couples the user equipment communication processor 203 and the IMS communication processor 209 together when an client-server IMS communication is supported.

The IMS communication processor 209 and the peer communication processor 207 are coupled to a network interface 211 which interfaces to the IMS core network 111 in order to receive and transmit data. In some embodiments, the network interface 211 may furthermore provide a direct connection to the second CPE 109.

The peer communication processor 207 is capable of supporting a peer-to-peer second communication session with a second access network element supporting a peer-to-peer communication session with a second user equipment. Specifically, the peer communication processor 207 is arranged to set up a peer-to-peer communication session with the second CPE 109 and to exchange data with this CPE 109 using this communication session. Specifically, the peer communication processor 207 can comprise SIP server/client functionality that uses the SIP protocol as specified in IMS to interface with a corresponding SIP server/client functionality in the second CPE 109.

The second CPE 109 comprises similar functionality and specifically comprises corresponding functionality for establishing a peer-to-peer communication with the second user equipment 103 and the peer-to-peer communication with the first CPE 107.

Thus, the two CPEs 107, 109 comprise functionality for supporting a peer-to-peer communication between the two user equipments 101, 103 without requiring that this communication is controlled and managed centrally in the IMS network.

The first CPE 107 furthermore comprises functionality for authenticating the involved entities.

Firstly, the CPE 107 comprises an authentication processor 209 which is coupled to the network interface 211. The authentication processor 211 comprises functionality for communicating with the HSS 113 of the IMS network in order to authenticate the first CPE 107.

Thus, initially the first CPE 107 authenticates itself at the HSS 113. Thus, the HSS 113 functions as a centralised authentication server thereby allowing a network operator to retain control of the network despite the distribution of functionality. As part of this authentication process, the first CPE 107 may furthermore receive various authentication data from the HSS 113. For example, the first CPE 107 may receive authentication data which relates to one or more user equipments that are registered with the first CPE 107.

The authentication of the first CPE 107 can follow standard IMS authentication procedures and may for example involve transmission of authentication challenges and verification of the responses to these authentication challenges. Following the initial authentication of the first CPE 107, this may proceed to authenticate user equipments that are attached to the CPE 107. Specifically, the authentication processor 213 is coupled to a user equipment authentication processor 215 which supports authentication of the first user equipment 101 in response to the authentication of the first CPE 107. Specifically, the authentication of the first user equipment 101 by the first CPE 107 is subject to the first CPE 107 already being authenticated by the authentication processor 213.

The authentication of the first user equipment 101 may be performed in different ways in different embodiments. In the system of FIG. 2, the first user equipment 101 is authenticated by the HSS 113 with the first CPE 107 acting as a relay for the authentication data exchange. Thus, a logical connection is set up between the first user equipment 101 and the HSS 113 and the user authentication is performed using standard IMS procedures. However, the first user equipment 101 will only be authenticated if the first CPE 107 has already been authenticated.

As another example, the user equipment authentication processor 215 may itself proceed to perform an authentication of the first user equipment 101. Specifically, the authentication data received from the HSS 113 may comprise indications of suitable authentication challenges to be transmitted to the first user equipment 101 as well as indications of the appropriate responses from the first user equipment 101 to these challenges. Accordingly, the user equipment authentication processor 215 may proceed to transmit the authentication challenges to the first user equipment 101 and to receive authentication responses from the first user equipment 101. These responses can then be compared to the expected responses and the first user equipment 101 may be considered authenticated if the received and expected responses match.

In order to establish the peer-to-peer communication between the first user equipment 101 and the second user equipment 103, a peer-to-peer communication is set up between the first CPE 107 and the second CPE 109.

As part of the setup, the first CPE 107 proceeds to authenticate the second CPE 109. Specifically, the first CPE 107 comprises a peer authentication processor 217 coupled to the peer communication processor 207 and to the authentication processor 213. The peer authentication processor 217 is arranged to authenticate the second CPE 109 before establishing the second communication session.

In the example, the authentication processor 217 transmits a number of authentication challenges directly to the second CPE 109 (i.e. without involving any centralised IMS server). In response, the second CPE 109 returns authentication responses which the peer authentication processor 217 compares to the expected responses. If the authentication responses match the expected responses, the first CPE 107 considers the second CPE 109 to be authenticated.

It will be appreciated that in order to setup the second communication session, the second CPE 109 may proceed to authenticate the first CPE 107 using a similar technique. Thus, bilateral peer-to-peer authentication of both CPEs 107, 109 is achieved.

The specific authentication challenges and/or the appropriate authentication responses may be received from the centralised authentication server implemented by the HSS 113. For example, when the first CPE 107 authenticates with the HSS 113, the HSS 113 may furthermore provide indications of authentication challenges and/or authentication responses for each CPE which is listed in the HSS 113 as being a potential peer of the first CPE 107. Similarly, the HSS 113 may provide data indicating which authentication responses the first CPE 107 should provide to other peers transmitting authentication challenges to the first CPE 107.

Thus, the system allows peer-to-peer communication session set up while ensuring that all the involved entities are securely authenticated entities. Furthermore, although the authentication functionality is distributed in the individual CPEs, the network operator is provided with a centralised tool for managing the authentication information thereby retaining the network operator's control of the network.

Specifically, in the system, the HSS 113 is ultimately the responsible entity for the authentication of any CPE entity and any end-user entity. For example, the CPE can allow user equipment authentication e.g. by relaying the authentication handshake between the user identity module (e.g., a Subscriber Identity Module (SIM)) and the HSS 113. However, this relay is only possible after successful CPE authentication. Also, the HSS 113 ensures that the peer-to-peer IMS services are between legitimate users.

The system of FIG. 1 furthermore supports mobility of the user equipments 101, 103 which can use peer-to-peer communications. Specifically, a CPE typically has a number of user equipments registered with it, i.e. it is a home CPE for a group of user equipments. A user's home CPE corresponds to the CPE which is the default routing location for the user equipment.

However, as users move, the user equipments may attach to CPEs which are not the home CPE of the user equipments. In this case, a CPE is said to be a visitor CPE for the user equipment.

The first CPE 107 accordingly comprises a subscriber processor 219 which has functionality for managing attachments from both home user equipments as well as visiting user equipments. The subscriber processor 219 is coupled to a subscriber store 221 which stores subscriber information for the subscribers having the first CPE 107 as a home CPE.

When the first CPE 107 receives an attachment request from a user equipment 101, 103 the attachment is fed to the subscriber processor 219. The subscriber processor 219 then proceeds to determine if the attaching user equipment belongs to the group of user equipments which are registered as having the first CPE 107 as the home CPE.

If so, the subscriber processor 219 proceeds to retrieve the appropriate subscriber data from the subscriber store 221. The subscriber data is then fed to the user equipment communication processor 203 which proceeds to establish appropriate communication sessions in accordance with the subscriber data.

However, if the attachment data indicates that the user equipment does not belong to the home group, the subscriber processor 219 proceeds to send a message to a remote subscriber server requesting that subscriber data for the attaching user equipment is provided. Specifically, the subscriber processor 219 transmits a message to the HSS 113 requesting that the appropriate subscriber data is sent to the first CPE 107. In response, the HSS 113 transmits the subscriber data to the first CPE 107 where it is fed from the subscriber processor 219 to the user equipment communication processor 203. The user equipment communication processor 203 then proceeds to set up the communication session(s) for the user equipment using the subscriber data obtained from the HSS 113.

The subscriber data may for example include the authentication data which is required by the user equipment authentication processor 215 to authenticate the user equipment. Thus, in some embodiments, the first CPE 107 may locally store authentication information required to authenticate any user equipments registered with the first CPE 107. However, if a visiting user equipment attaches to the first CPE 107, appropriate authentication data for this user equipment is retrieved from the HSS 113 thereby allowing the first CPE 107 to perform an authentication of the attaching user equipment.

The subscriber data may alternatively or additionally comprise security data for the communication. For example, the subscriber data may indicate specific security algorithms or keys to be applied for communication sessions with the attaching user equipment. Specifically, the downloaded subscriber data may include a public key for the attaching user equipment.

As another example, the subscriber data may comprise service data indicative of characteristics, restrictions or preferences for the services provided to the user equipment. For example, the subscriber data may include a list of services to which the subscriber of the attaching user equipment is subscribed or may e.g. comprise an indication of a service level appropriate for the subscription of the user (e.g. the system may provide different grades of services for different users e.g. depending on the cost of the subscription).

Furthermore, in order to support mobility, the first CPE 107 may transmit an attachment message to a remote mobility server indicating that the visiting user equipment has attached to the first CPE 107. This may allow the network to locate the attaching user equipment despite this not being attached to its home CPE. Such an attachment message is not transmitted until the authentication of the attaching user equipment has been successfully completed in order to ensure a reliable system and to reduce signalling overhead. In the specific sample, the remote mobility server is part of the HSS 113, and the first CPE 107 accordingly transmits a message to the HSS 113 indicating that the attaching user equipment is currently attached to the first CPE 107. The HSS 113 stores this information. Hence, if another user equipment seeks to set up a communication session with the attaching user equipment, the CPE serving this user equipment may contact the HSS 113 in order to retrieve location information for the attaching user equipment thereby allowing it to setup the communication session.

In some embodiments, the individual CPEs may comprise peer lists that identify other user equipments and CPEs that may be used to establish peer-to-peer communications. For example, a group of users may be registered in the HSS 113 as a peer group. The address of the home CPE for each user may be included in a peer list which is transmitted to all home CPEs of the group. Accordingly, when one of the home CPEs detects that a home user equipment seeks to setup a communication session with another user equipment of the peer list, it may proceed to set this communication session up as a peer-to-peer communication involving a peer-to-peer communication between the CPE and the home CPE of the user equipment.

Furthermore, in order to support mobility, the HSS 113 may distribute a new peer list whenever an attachment message is received indicating that one of the user equipments of the peer group has attached to a visited CPE. In this case, information identifying the user equipment and the visited CPE is transmitted to all the home CPEs of the peer list, as well as to any visited CPEs. Furthermore, a full peer list is transmitted to the new visitor CPE thereby allowing this to support peer-to-peer communications for the attaching user equipment. As another example, prior to setting up a peer-to-peer communication between two home CPEs, a CPE may contact the HSS 113 to obtain up-to-date mobility information.

In some embodiments, the service provided to the user equipment may be different depending on whether the user equipment is attached to its home CPE or to a visited CPE. For example, if the visited CPE is owned by another network operator, the available services may be determined by a Service Level Agreement (SLA) between the network operators. In such cases, the application server 115 may be used to provide information of the available services, either directly or via the HSS 113.

As mentioned previously, the first CPE 107 comprises functionality both for supporting peer-to-peer communications as well as more traditional ISM based client-server communications (e.g. to the third user equipment 105).

Specifically, the communication controller 205 can couple the user equipment communication session with a peer-to-peer communication session supported by the peer communication processor 207 or with an IMS client-server communication supported by the IMS communication processor 209. In the specific example, the communication controller 205 selects between the two modes depending on whether the other user equipment involved in the communication session is included in the peer list not.

Specifically, if the first user equipment 101 initiates a communication session with another user equipment, the communication controller 205 evaluates whether this user equipment is listed in the peer list. If so, it proceeds to activate the peer communication processor 207 to set up a peer-to-peer communication session with the CPE associated with this user equipment in the peer list. If not, the IMS communication processor 209 is activated to set up an IMS based client-server communication session using the centralised IMS servers and functionality.

In the system of FIG. 2, the I-CSCF supporting the third user equipment provides IMS functionalities and furthermore supports the peer-to-peer communications. Specifically, for an IMS session originated by the third user equipment 105 and terminating at the first user equipment 101, the I-CSCF will contact the HSS 113 to obtain the name of the home-CPE controlling the first user equipment 101 (i.e. the first CPE 107) and forward SIP requests/responses to this.

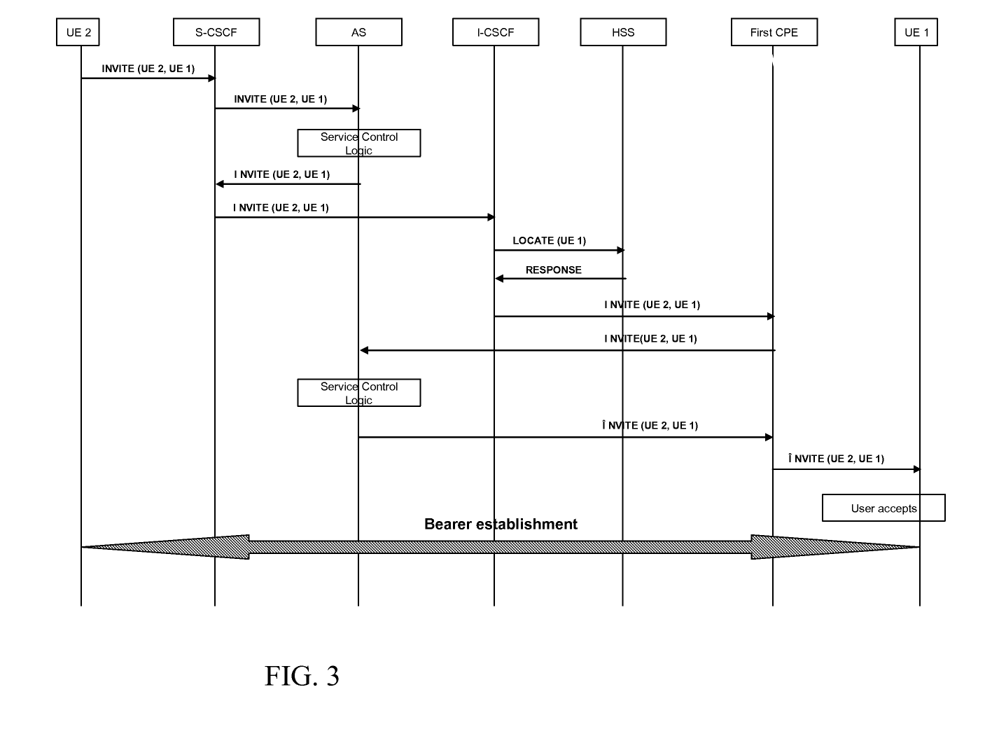

FIG. 3 shows an example of a specific message flow for a scenario in which a user registered in the IMS network (e.g. the third user equipment 105 referred to as UE 2) calls a user registered in the peer-to-peer enabled sub-network (e.g. the first user equipment 101 referred to as UE 1).

In the example, the following messaging is exchanged:
1) The S-CSCF of UE 2 (the third user equipment) receives a SIP INVITE request from UE 2.
2) Based on the information obtained from the UE 2 Service Profile (during registration), the S-CSCF of UE 2 detects that the criteria for certain pre-defined triggers are met. For instance, UE 1 is not found as ‘registered’ in the IMS domain. The INVITE request is forwarded to the Application Server. The service logic is invoked in the Application Server.
3) Based on the outcome of the execution of the service logic, the Application Server sends a modified INVITE request (e.g., INVITE) back to the S-SCSF. The Application Server behaves similar to a ‘proxy server’. For instance, the INVITE request could contain an ‘Inter Operator Indication’ (e.g., IOI) to highlight that UE 1 might be registered on another network.
4) The S-CSCF of UE 2 forwards the INVITE request to the I-CSCF of UE 2.
5) The I-CSCF of UE 2 queries the HSS to obtain the S-CSCF of UE 1.
6) The HSS returns the location of the first CPE to which UE 1 is registered.
7) The I-CSCF forwards the INVITE request to the first CPE.
8) Based on the information obtained from the UE 1 Service Profile (during registration), the first CPE detects that the criteria for certain pre-defined triggers are met. For instance, the presence of the IOI may indicate that some extra charging will be applied to the called user. The INVITE request is forwarded to the Application Server. The service logic is invoked in the Application Server.
9) Based on the outcome of the execution of the service logic, the Application Server sends a modified INVITE' request (e.g. ÎNVITE) back to the first CPE. The Application Server behaves similar to a ‘proxy server’. For instance, the ÎNVITE request could contain an ‘IMS Charging ID’ (e.g., ICID) to highlight that extra charging might be applied to the UE 1 end-user.
10) The first CPE forwards the SIP ÎNVITE request to UE 1. The end-user accepts and the bearer is established.

In the described system, the common HSS and AS platforms are used to implement both conventional and peer to peer IMS architecture aspects. Such an approach may substantially facilitate entry for new operators who will typically be starting off with a low IMS subscriber count but will eventually move to a full standard IMS implementation when the subscriber count increases.

It will be appreciated that the described approach is allows significant scalability and manageability. E.g. the user equipments can communicate via the respective CPEs, which will guarantee session control and management for a wide variety of IP multimedia sessions and for a wide variety of session re-configuration scenarios. Also, control, upgrade, inventory, and fault management of IMS functionalities are mainly maintained using known CPE operations and management procedures.

The system is furthermore a low entry cost system since a CPE can be added in different environments (small offices, bars, airport lounges, commercial centers etc.) according to the subscriber penetration rate and concentration. Specifically, the described architecture does not require a substantial initial investment in a centralized call/session control platform.

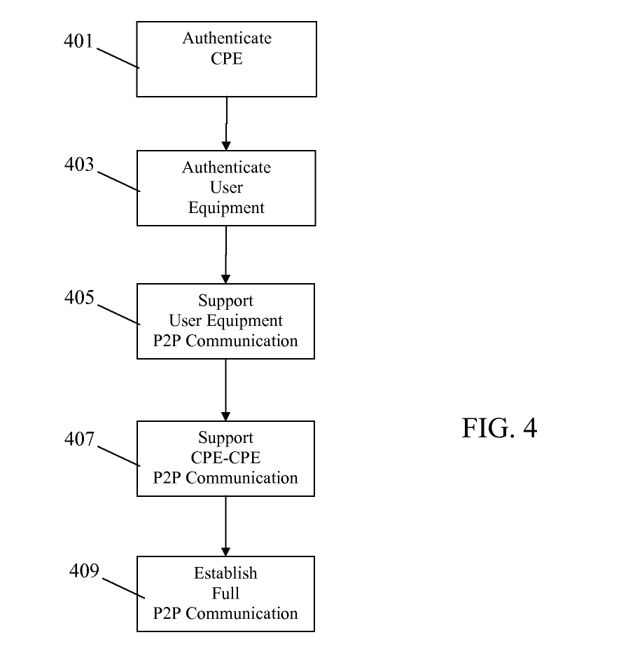

FIG. 4 illustrates a method of operation for an access network element in accordance with some embodiments of the invention. The access network element provides access to a network for user equipments. The network comprises a centralised authentication server.

The method initiates in step 401 wherein the access network element is authenticated at the centralised authentication server.

Step 401 is followed by step 403 wherein the first user equipment is authenticated in response to the authentication of the access network element by the centralised authentication server.

Step 403 is followed by step 405 wherein a peer-to-peer first communication session is supported for the first user equipment.

Step 405 is followed by step 407 wherein a peer-to-peer second communication session is supported with a second access network element supporting a peer-to-peer communication session with a second user equipment.

Step 407 is followed by step 409 wherein a peer-to-peer communication is supported between the first and second user equipments by exchanging data between the first communication session and the second communication session.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An access network element for providing access to a network for user equipments, the network comprising a centralised authentication server and the access network element comprising:
first authentication means for authenticating the access network element at the centralised authentication server;
second authentication means for authenticating the first user equipment in response to the authentication of the access network element by the centralised authentication server;
first communication session means for supporting a peer-to-peer first communication session for the first user equipment;
second communication session means for supporting a peer-to-peer second communication session with a second access network element supporting a peer-to-peer communication session with a second user equipment; and
means for supporting a peer-to-peer communication between the first and second user equipments by exchanging data between the first communication session and the second communication session.

2. The access network element of claim 1 further comprising third authentication means for authenticating the second access network by transmitting an authentication challenge to the second access network element; and comparing a received authentication response from the second access network element to an expected response.

3. The access network element of claim 2 further comprising means for receiving an indication of the expected response from the centralised authentication server.

4. The access network element of claim 1 wherein the centralised authentication server is an Internet Protocol Multimedia Subsystem, IMS, Home Subscriber Server, HSS.

5. The access network element of claim 1 wherein at least one of the first and second communication sessions uses a Session Initiation Protocol, SIP.

6. The access network element of claim 5 wherein the SIP protocol is an Internet Protocol Multimedia Subsystem, IMS, SIP protocol.

7. The access network of claim 1 further comprising means for determining if the first user equipment belongs to a group of registered user equipments registered for the access network element; and subscriber data means for retrieving subscriber data for the first user equipment from a remote subscriber server if the first user equipment does not belong to the registered group.

8. The access network element of claim 7 further comprising a subscriber data store for storing subscriber data for the registered group; and wherein the subscriber data means is arranged to retrieve subscriber data for the first user equipment from the subscriber data store if the first user equipment belongs to the group.

9. The access network element of claim 7 further comprising means for transmitting an attachment message to a remote mobility server if an authentication of the first remote terminal is successful and the first user equipment does not belong to the registered group, the attachment message indicating that the first user equipment is attached to the access network element.

10. The access network element of claim 7 wherein the subscriber data comprises at least one of security data and service data for a subscriber associated with the first user equipment.

11. The access network element of claim 7 wherein the remote subscriber server is a Home Subscriber Server, HSS, of an Internet Protocol Multimedia Subsystem, IMS.

12. The access network element of claim 1 further comprising:
third communication session means for managing a client-server third communication session with a serving network element supporting a client server communication session with a third user equipment; and
means for supporting a communication between the first and third user equipment by exchanging data between the first communication session and the third communication session.

13. The access network element of claim 12 wherein the serving network element comprises a Serving-Call Session Control Function, S-CSCF, of an Internet Protocol Multimedia Subsystem, IMS.

14. The access network element of claim 12 further comprising initializing means for initializing a communication with a destination user equipment, the initializing means being arranged to select between the second and third communication sessions depending on a characteristic of the destination user equipment.

15. The access network element of claim 14 further comprising means for storing a list of peer-to-peer user equipments for the first user equipment; and wherein the selection means is arranged to select the second communication session only if the destination user equipment is included in the list.

16. The access network element of claim 7 wherein the first authentication means is arranged to receive authentication data for the first user equipment from the centralised authentication server; and the second authentication means is arranged to authenticate the first user equipment in response to the authentication data.

17. The access network element of claim 1 wherein the access network element is a Customer Premises Equipment.

18. A communication network comprising at least one a centralised authentication server and a plurality of access network elements for providing access to the network for user equipments, at least one access network element of the plurality of access network elements comprising:
first authentication means for authenticating the access network element at the centralised authentication server;
second authentication means for authenticating the first user equipment in response to the authentication of the access network element by the centralised authentication server;
first communication session means for supporting a peer-to-peer first communication session for the first user equipment;
second communication session means for supporting a peer-to-peer second communication session with a second access network element supporting a peer-to-peer communication session with a second user equipment; and
means for supporting a peer-to-peer communication between the first and second user equipments by exchanging data between the first communication session and the second communication session.

19. The communication network of claim 19 wherein the communication network is an Internet Protocol, IP, Multimedia Subsystem, IMS.

20. A method of operation for an access network element providing access to a network for user equipments, the network comprising a centralised authentication server and the method comprising:
authenticating the access network element at the centralised authentication server;
authenticating the first user equipment in response to the authentication of the access network element by the centralised authentication server;
supporting a peer-to-peer first communication session for the first user equipment;
supporting a peer-to-peer second communication session with a second access network element supporting a peer-to-peer communication session with a second user equipment; and
supporting a peer-to-peer communication between the first and second user equipments by exchanging data between the first communication session and the second communication session.
